(19) United States
(12) Patent Application Publication
(10) Pub. No.: US 2006/0055966 A1
(43) Pub. Date: Mar. 16, 2006

(54) Print system

(75) Inventor: Kaname Nihei, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/227,166

(22) Filed: Sep. 16, 2005

(30) Foreign Application Priority Data
Sep. 16, 2004 (JP) 2004-270059

(51) Int. Cl. G06F 3/12

(52) U.S. Cl. 358/1.15

(57) ABSTRACT

The present invention provides a print system, comprising: an image data read device which reads image data from a recording medium of a user; an order acceptance device which accepts an order for print of image data read by the image data read device; a print device which prints the image data based on order contents accepted by the order acceptance device; an accessory information read device which reads accessory information associated with the image data; a printing price storage device which stores a printing price depending on the accessory information; and a printing price determination device which determines a printing price by referring to the printing price storage device according to the accessory information read by the accessory information read device.

### BACKGROUND OF THE INVENTION

1. Field of the Invention

The present invention relates to a print system, and more specifically to a print system for providing a print service of printing image data depending on an order from a user.

2. Related Art

Conventionally, a system of reducing a printing fee through an advertisement, etc. when a print service of a film and image data of a user is offered in a shop dealing with a minilab, etc. has been developed. For example, Japanese Patent Application Laid-Open No. 2001-350202 discloses a photo print device includes a print data storage unit for storing print data for an advertisement, a data input unit for inputting print data for the advertisement to the print data storage unit, a print head for printing the advertisement on the recording paper based on the print data for the advertisement stored in the print data storage unit, and a printing fee calculation device for calculating a fee for manufacturing a photo print. The printing fee calculation device is set such that the manufacturing fee for a photo print with a printed advertisement is lower than the manufacturing fee for a photo print without a printed advertisement.

Japanese Patent Application Laid-Open No. 2003-242242 discloses a print order server for retrieving product management information at a print factory side, selecting a print factory according to order information (user request for a printing fee, a print delivery term, etc.) input from a terminal of a user, and changing a printing price and a print delivery term based on the change rate of the printing price and print delivery term depending on the season and the availability.

### SUMMARY OF THE INVENTION

In the photo print device disclosed by Japanese Patent Application Laid-Open No. 2001-350202, it is necessary to select by a user's operating a console whether or not generating a print including an advertisement (whether or not a print for a lower printing fee is to be selected) (paragraph 0020). Additionally, the print order server disclosed by Japanese Patent Application Laid-Open No. 2003-242242 changes a printing price and a print delivery term depending on the season and availability (degree of operation), and is different in configuration from the present invention.

The present invention has been developed to solve the above-mentioned, and aims at providing a print system in which a printing fee is automatically set depending on the type of print-ordered image data.

To attain the above-mentioned objective, the print system according to the first aspect of the present invention includes: an image data read device which reads image data from a recording medium of a user; an order acceptance device which accepts an order for print of image data read by the image data read device; a print device which prints the image data based on order contents accepted by the order acceptance device; an accessory information read device which reads accessory information associated with the image data; a printing price storage device which stores a printing price depending on the accessory information; and a printing price determination device which determines a printing price by referring to the printing price storage device according to the accessory information read by the accessory information read device.

With the print system according to the first aspect, a printing price can be freely set according to the accessory information associated with image data. Therefore, various services can be provided.

The print system according to the second aspect of the present invention is based on the first aspect, and the accessory information is at least one of information about the manufacturer of a camera used in taking the image data, a shooting date, and a shooting place.

The print system according to the third aspect of the present invention is based on the first or second aspect, and further includes a printing price change device which changes a printing price stored in the printing price storage device.

With the print system according to the third aspect, a printing price depending on the accessory information associated with image data can be optionally set.

According to the present invention, a print service can be provided at a printing price depending on the accessory information associated with image data. Therefore, various services such as a campaign, etc. for setting a special printing price depending on the manufacturer of a camera, the shooting condition such as a shooting date, place, etc. can be provided.

### BRIEF DESCRIPTION OF THE DRAWINGS

FIG. 1 shows an appearance of the print system according to an embodiment of the present invention;

FIG. 2 is a block diagram of the internal configuration of the print system 10;

FIG. 3 is a flowchart showing the printing price setting method;

FIG. 4 shows an example of a printing price setting screen;

FIG. 5 is a flowchart showing the print service providing method of the print system 10;

FIG. 6 is a schematic chart of the format of image data; and

FIG. 7 is a flowchart of the printing price adjusting step in step S30 shown in FIG. 5.

### DETAILED DESCRIPTION OF THE PREFERRED EMBODIMENTS

The preferred embodiments of the present invention are described below by referring to the attached drawings.

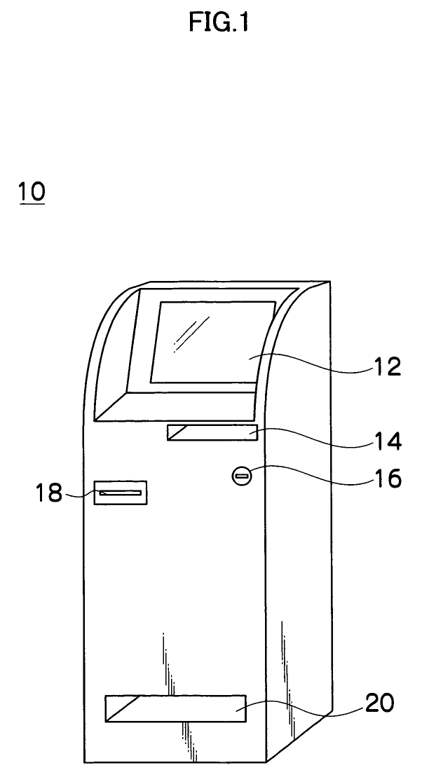

FIG. 1 shows the appearance of the print system according to an embodiment of the present invention. A print system 10 shown in FIG. 1 is a self-service device at a shop placed near, for example, the entrance of a shop dealing with a minilab and a DPE shop, etc., and a user prints an image in a self-service system.

As shown in FIG. 1, a display device 12, an image input unit 14, a coin slot 16, a receipt outlet 18, and a print outlet 20 are provided on the front face of the print system 10.

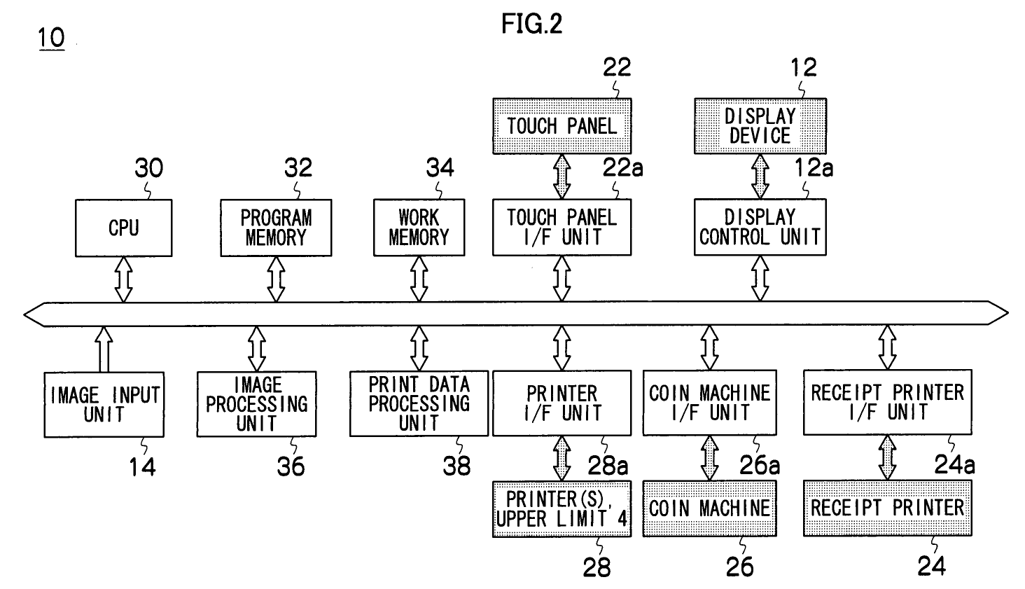

The display device 12 displays an operation menu and image data, and can be, for example, a CRT and a liquid crystal display (LED). A touch panel (reference numeral 22 shown in FIG. 2) is mounted on the surface of the display device 12.

The image input unit 14 allows a user to input image data includes an adapter, etc. for cable communications and radio communication for direct input of image data from a media reader, a digital camera, a mobile telephone with a camera, etc. for semiconductor memory such as an xD picture card, a CompactFlash (CF) card, SmartMedia, an SD memory card (registered trademark), a PC card, etc. and various recording media such as a flexible disk, a magneto optical disk (MO), a CD-R/RW, DVD-RAM, DVD-R/RW, etc.

FIG. 2 is a block diagram of the internal configuration of the print system 10. As shown in FIG. 2, the display device 12 is connected to a main bus through a display control unit 12a. A touch panel 22, a receipt printer 24, a coin machine 26, and a printer 28 are connected to the main bus through respective 1F units 22a to 28a.

A CPU (central processing unit) 30 shown in FIG. 2 is a control unit for integrally controlling the print system 10. The CPU 30 controls the operation of each device in the print system 10 based on the operation input from the touch panel 22, etc.

Program memory 32 is ROM storing a program to be executed by the CPU 30, various types of data etc. required for control.

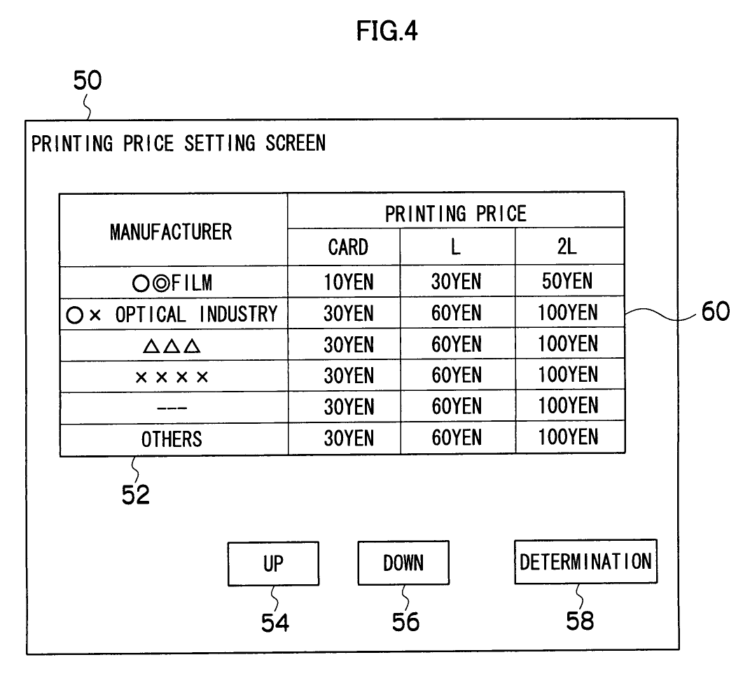

Work memory 34 includes SDRAM, etc. as a storage area storing image data input from the image input unit 14 and a work area in which the CPU 30 performs various arithmetic operations, etc. The work memory 34 stores a printing price table described later (reference numeral 52 shown in FIG. 4).

An image processing unit 36 processes an image (for example, a decompressing process, etc. on a compressed image) input from the image input unit 14.

A print data processing unit 38 converts an image processed by the image processing unit 36 converts an image processed by the image processing unit 36 to a data format for print.

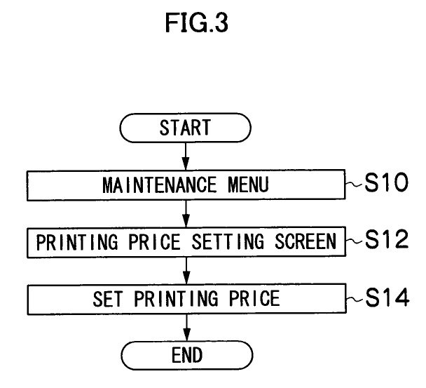

Next, a method of setting a printing price in a print system is explained. FIG. 3 is a flowchart of the printing price setting method.

First, when an operator of the print system 10 performs a predetermined operation, the display device 12 displays a maintenance menu (step S10), and a printing price setting screen is displayed (step S12). Then, by the operation input by the operator through the touch panel 22, a printing price is set (step S14).

FIG. 4 shows an example of a printing price setting screen. A printing price setting screen 50 shown in FIG. 4 has a printing price table 52 and operation buttons (an up button 54, a down button 56, and a determination button 58).

The printing price table 52 records a printing price depending on the name of the manufacturer used in taking image data to be printed and the print size (card size, L size, 2L size, etc.). The manufacturer name and the print size are not limited to those shown in FIG. 4, but can be optionally set by an operator.

When a printing price is changed on the printing price setting screen 50, first, an operation touches the display area (for example, the area 60 of the manufacturer “xx Optical Industry” and the size “2L”) of the price to be changed, the area 60 is selected and blinks. Next, when the operator touches the up button 54 or the down button 56, the printing price of the area 60 is increased or decreased by a predetermined amount (for example, by 10 yen). When the operator touches the determination button 58, the printing price is determined and recorded in the work memory 34 (FIG. 2).

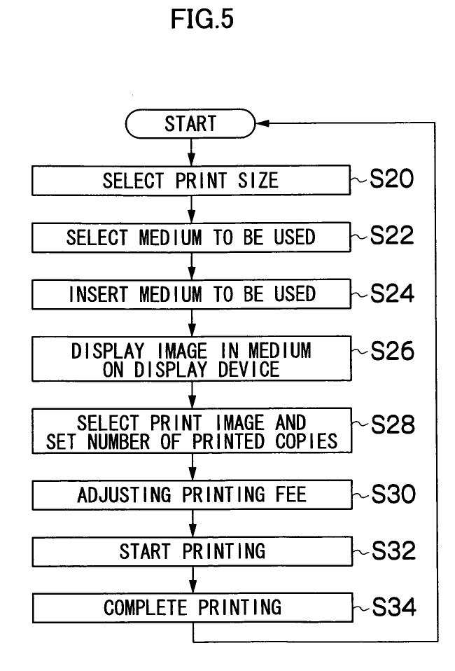

Described next is the print service providing method of the print system 10. FIG. 5 is a flowchart of the print service providing method of the print system 10.

First, at the starting time, the display device 12 displays a standby state screen (standby screen such as “Welcome” displayed before the operator inputs an operation). When a user operates the touch panel 22, the screen is switched to a normal service screen for input of an operation by the user.

Then, the user selects a print size by operating the touch panel 22 (step S20), and selects the type of recording medium to be used (step S22). When the user inserts the recording medium into the media reader of the image input unit 14 (step S24), image data recorded on the recording medium is read and displayed on the display device 12 (step S26).

Then, the user selects an image to be printed from among the images displayed on the display device 12 by operating the touch panel 22. When the number of prints of each of the selected images is set (step S28), the printing fee is adjusted (step S30). Then, printing the selected image is started on the printer 28 (step S32). When the printing is completed (step S34), control is returned to the standby state screen (start).

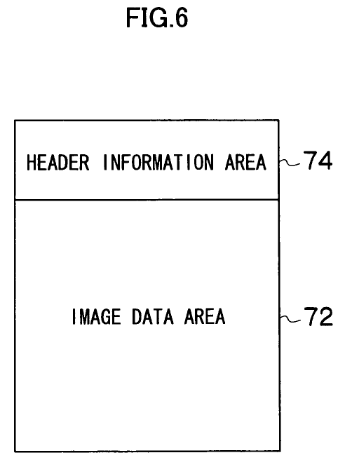

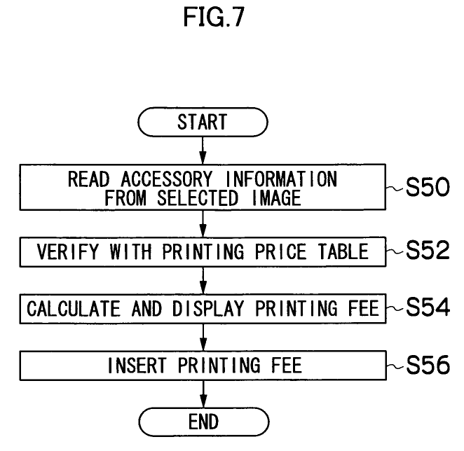

The printing fee adjusting step in step S30 is explained below by referring to FIGS. 6 and 7.

FIG. 6 is a schematic chart of the format of image data. As shown in FIG. 6, an image data 70 comprises an image data area 72 and a header information area 74.

The image data area 72 is an area storing image data. On the other hand, the header information area 74 is a storage area for accessory information (for example, exif tag information,) and stores the creation date (a shooting date, an updated date, etc.) and size of the image data 70, and the manufacturer information about the camera used in a shooting operation, etc.

FIG. 7 is a flowchart of the printing fee adjusting step in step S30 shown in FIG. 5. In step S28, accessory information is read from the image data selected in step S28 (step S50).

Then, the manufacturer information about the camera used in the shooting operation contained in the accessory information read in step S50 is verified with the printing price table 52 of the work memory 34 (step S52), the printing fee is calculated based on the print size and the number of printed copies set in steps S20 and S28 shown in FIG. 4, and displayed on the display device 12 (step S54). When a user puts a printing fee (step S56), the printing operation is started (step S32 in FIG. 4).

According to the present embodiment, a printing price can be set for each manufacturer of the camera used in taking image data. Therefore, by setting a special printing price for a user of the camera of a specific manufacturer which provides the print system 10, the print service of the manufacturer can be promoted and an advertisement of the camera manufacturer can be effectively realized.

In the present embodiment, a printing price is set according to the manufacturer information about the camera used in a shooting operation, but, for example, the shooting date and time, and the shooting place (for example, when a camera having the GPS function is used), etc. can be used, and these pieces of information can be combined and used. For example, lowering the printing price of an image taken during a predetermined period (for example, a camera sales campaign) can be used in a campaign for sales of a camera of a camera manufacturer in the term-limited campaign. Furthermore, when a printing price is set according to the shooting place information, a printing price of an image shot as a predetermined place, etc. can be lowered, thereby efficiently using the means in a place-limited campaign.

Furthermore, in the present embodiment, a print system is explained above as a self-service terminal device mounted near the entrance of a shop. It can also be used as a print system for accepting an order for print through the Internet or at the counter of a shop, and a printing price can be set as in other embodiments of the present invention.

What is claimed is:

1. A print system, comprising:
an image data read device which reads image data from a recording medium of a user;
an order acceptance device which accepts an order for print of image data read by the image data read device;
a print device which prints the image data based on order contents accepted by the order acceptance device;
an accessory information read device which reads accessory information associated with the image data;
a printing price storage device which stores a printing price depending on the accessory information; and
a printing price determination device which determines a printing price by referring to the printing price storage device according to the accessory information read by the accessory information read device.

2. The print system according to claim 1, wherein
the accessory information is at least one of manufacturer information about a camera used in taking the image data, a shooting date, and a shooting place.

3. The print system according to claim 1, further comprising
a printing price change device which changes a printing price stored in the printing price storage device.

4. The print system according to claim 2, further comprising
a printing price change device which changes a printing price stored in the printing price storage device.
